(19) United States
(12) Patent Application Publication
(10) Pub. No.: US 2022/0358418 A1
(43) Pub. Date: Nov. 10, 2022

(54) System and Method for Organization and Verification of Live Events

(71) Applicant: Omer Salik, Hermosa Beach, CA (US)

(72) Inventor: Omer Salik, Hermosa Beach, CA (US)

(21) Appl. No.: 17/308,611

(22) Filed: May 5, 2021

(51) Int. Cl. G06Q 10/02; G06K 7/14; G06Q 20/18

(52) U.S. Cl. CPC G06Q 10/02; G06K 7/1417; G06Q 20/18

(57) ABSTRACT

A system and method for organizing events, confirming guests to attend events and verifying attendance at events. The system and method includes receiving from a first user information regarding an in-person event hosted by said user, confirming attendees to said event, and verification of attendance at the event utilizing mobile device geo-location and proximity detection. The system and method may include a payment and rating system for users based on verification of duration of attendance at events.

### FIELD OF THE INVENTION

The present disclosure relates generally to online and mobile services and user interfaces therefor, and more particularly, to organizing, verifying, securing, measuring and incentivizing real-world interactions, transactions and engagements.

### BACKGROUND OF THE INVENTION

Many resources are available for providing people the ability to connect with other people in the community for social or economic purposes. For example, online social networking and dating services allow people to connect over the internet to exchange information and facilitate virtual and real-world interactions. Other websites and mobile applications allow people to post jobs or services they need performed by freelancers for a negotiated fee.

Utilization of online services for the performance of jobs or services continues to be limited by risks and challenges inherent with two strangers seeking to interact and contract with each other. Specifically, the hiring person continues to carry the risk that the person hired will not show up, will not be the person advertised or performs the job or service unsatisfactorily. In these situations, the hiring person faces the risk of not having the service performed, losing money already paid or having a contentious confrontation with the person hired. Likewise, the person being hired faces the risk of non-payment, a hostile or unpleasant engagement or confrontation.

Within certain service sectors, such as taxi, delivery and certain professional services, online hiring has improved in recent years by providing transparent payment terms, backend performance verification, backend payment facilitation and rating systems for both service providers and service consumers. But these efficiencies have not been extended to other service sectors that involve more personalized services and require greater interpersonal interactions between the hirer and the service provider. Referral systems also fail to provide an objective rating system, leaving the rating of users to subjective ratings of other users that may be false or unfair.

In other service sectors that entail more personalized services, a longer engagement or interpersonal interactions, current websites either only provide for referrals. Online referral systems are limited, because they do not allow for a secure platform that serves as the intermediary for verifying the satisfaction of both the hirer and the service provider. Other online services vet the individual service providers within their network and facilitate payment between the customer and service provider, but these services interpose a substantial cost, both increasing the price paid by the hirer and reducing the amount received by the service provider.

There continues to be a need, therefore, for an online service that allows for an end-to-end, frictionless, low-risk hiring of service providers that ensures that the real-time incentives for both the customer and the service provider are aligned in the hiring and performance of personal services over an extended duration of time. There also continues to be a need for an online platform that allows for an accurate, objective and efficient rating and vetting of service providers without intensive screening by the platform operators.

### SUMMARY OF THE INVENTION

The present disclosure contemplates various systems and methods for an online platform facilitating posting a request for the performance of a job or service in an online platform seeking one or more other participants in the online platform to staff or fulfill those jobs and services. The participant hiring for and posting the job or service is referred to herein as the “host.” The requested job or service is referred to herein as an “event.” The one or more participants seeking to perform the requested job or service are referred to herein as “guests.”

The host posting the event specifies the details for the event, such as location, start time, end time, number of guests needed, guest compensation, guest attributes required, nature of the event and other details. In certain embodiments, the online service automatically calculates a payout schedule for guests attending the event. The host may post the event within the online platform to allow guests to view the posted event. The host may send requests or invitations to specific guests for an event. Alternatively, guests may request invitations from the host. In certain embodiments, if guest and host have confirmed guest's invitation and acceptance to attend the event, the host transfers the compensation amount to the online platform to hold in escrow.

In certain embodiments, the platform provides confirmation of guest attendance and performance of services and releases funds to guests based on their attendance and performance based on the predetermined payout schedule. In certain embodiments, the platform confirms the guest's attendance and performance through location and proximity data provided by their mobile device. In other embodiments, the platform provides a mechanism by which both hosts and guests may choose to continue or discontinue the participation in the event in real-time and prorates payments to guests according to a predetermined payment schedule.

The system and method may further include a rating system for both hosts and guests based, in part, in the duration times for attendance at events by guests. In certain embodiments, the system evaluates the duration of the event as posted and to the duration each guest stayed at the event, whether an invitation to stay from a host was accepted or rejected and whether a guest stayed until the end of the posted duration to calculate a payout and rating. In other embodiments, additional factors may be included in the rating system, such as individual rating assignments from other hosts and guests, complaints, cancellations or no-shows.

Certain other embodiments of the present disclosure contemplate respective computer-readable program storage media that each tangibly embodies one or more programs of instructions executable by a data processing device to perform the foregoing methods. The present disclosure will be best understood accompanying by reference to the following detailed description when read in conjunction with the drawings.

### BRIEF DESCRIPTION OF THE FIGURES

FIG. 1 is a block diagram of an online platform for implementing the embodiments disclosed herein.

FIG. 2 is a block diagram of a data structure for participant profile module.

FIG. 3 is a block diagram of a data structure for an event creation module.

FIGS. 4A-C are flow charts for a process for verifying attendance at an event.

FIGS. 5A-B are flow charts for a process for a payment system based on verification of attendance at an event.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The term “online platform” may be construed to mean a hardware architecture in which one or more servers electronically communicate with, and concurrently support interactions with, a plurality of client devices, thereby enabling each of the client devices to communicate with one or more servers or with one or more clients synchronously or asynchronously. Accordingly, an online platform is a computer-related technology, a non-generic technological environment, and should not be abstractly considered a generic method of organizing human activity divorced from its specific technology environment.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enable or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “module,” “application” or “engine” used in this disclosure may refer to computer logic utilized to provide a desired functionality, service or operation by programming or controlling a general purpose processor. Stated differently, in some embodiments, a module, application or engine implements a plurality of instructions or programmatic code to cause a general purpose processor to perform one or more functions. In various embodiments, a module, application or engine can be implemented in hardware, firmware, software or any combination thereof. The module, application or engine may be interchangeably used with unit, logic, logical block, component, or circuit, for example. The module, application or engine may be the minimum unit, or part thereof, which performs one or more particular functions.

The term “participant” or “user” used in this disclosure refers to a person operating a client device connected to the online platform.

The term “event” used in this disclosure refers to a live or virtual event, job, function, or service that a participant in the online platform seeks one or more other participants to perform, attend or execute.

The term “host” used in this disclosure refers to a participant that posts, advertises or publishes an event using the online platform.

The term “guest” used in this disclosure refers to a participant that may attend, perform or participate, in whole or in part, in an event.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

As used herein, the indefinite articles “a” and “an” mean “at least one” or “one or more” unless the context clearly dictates otherwise.

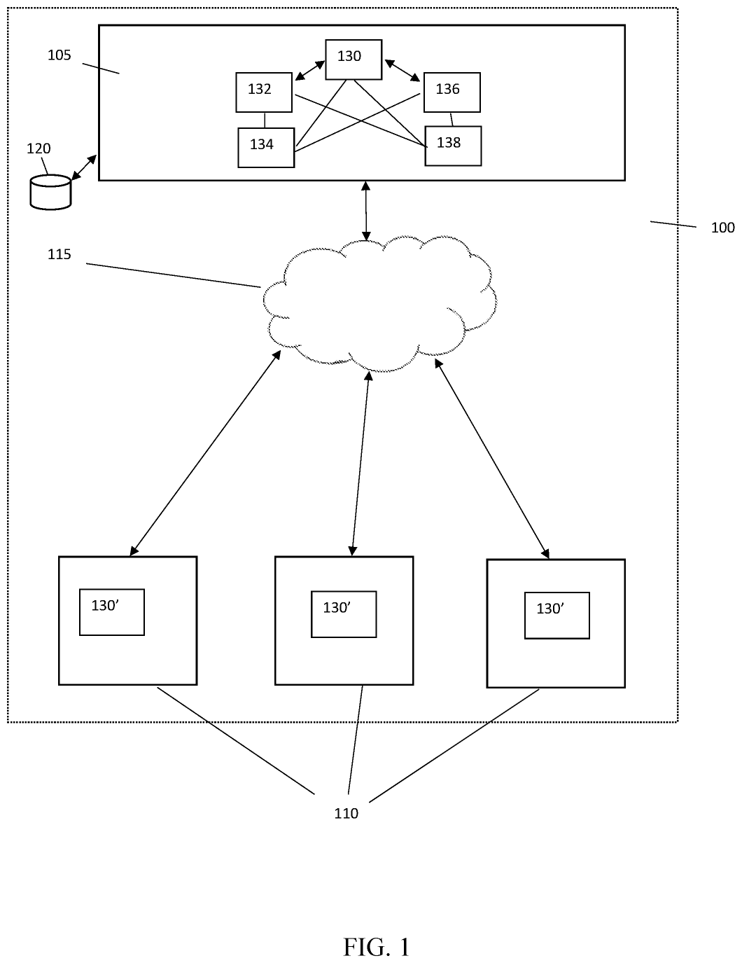

FIG. 1 illustrates an embodiment of an online platform system/environment 100 in which the systems and methods of the present specification may be implemented or executed. The system 100 comprises client-server architecture, where one or more servers 105 are in communication with one or more client devices 110 over a network 115. Participants, including hosts and guests, may access the system 100 via the one or more client devices 110. The client devices 110 comprise computing devices such as, but not limited to, personal or desktop computers, laptops, Netbooks, handheld devices such as smartphones, tablets, and PDAs, and/or any other computing platform known to persons of ordinary skill in the art. Although one server 105 and three client devices 110 are illustrated in FIG. 1, any number of servers 105 and client devices 110 can be in communication with one or more servers 105 over the network 115.

The one or more servers 105 can be any computing device having one or more processors and one or more computer-readable storage media such as RAM, hard disk or any other optical or magnetic media. The one or more servers 105 include a plurality of modules operating to provide or implement a plurality of functional, operational or service-oriented methods of the present specification. In some embodiments, the one or more servers 105 include or are in communication with at least one database system 120. The database system 120 stores a plurality of data associated with participants and events that is served or provided to the client devices 110 over the network 115. In some embodiments, the one or more servers 105 may be implemented by a cloud of computing platforms operating together as servers 105.

In accordance with aspects of the present specification, the one or more servers 105 provide or implement a plurality of modules or engines such as, but not limited to, a participant profile module 130, an event creation module 132, an event verification module 134, a payment module 136 and a rating module 138. In some embodiments, the one or more client devices 110 are configured to implement or execute one or more of a plurality of client-side modules that are the same as, complimentary to or similar to the modules of the one or more game servers 105. For example, in some embodiments each of the client devices 110 executes a client-side profile module 130′.

While various aspects of the present specification are being described with reference to functionalities or programming distributed across multiple modules or engines 132, 134, 136 and 138, it should be appreciated that, in some embodiments, some or all of the functionalities or programming associated with these modules or engines may be integrated within fewer modules or in a single module—such as, for example, in the event module 132 itself.

In embodiments, the participant profile module 130 is configured to execute and store the creation of an online profile for a user of the platform 100 to facilitate the creation of and participation in events, communications and interaction with other participants, verification and payment for hosting or attending events and a rating system associated with a profile. In embodiments, the interface provided by the client-side module 130′ enables participants to create their online profile with participant profile module 130 and seamlessly interact within and navigate through a plurality of user profiles stored in database 120. The client-side module 130′ also allows participants acting as hosts to create events for publication to other participants acting as guests through event creation module 132. Users can then use the client-side module 130′ to browse events stored in database 120 and presented to the users through the interface of the client-side module 130′. The client-side module 130′ can also enable communication between participants, such as text messaging, and provide data to the event verification module 134. The client-side module 130′ further facilitates making and receiving payments through payment module 136. Participant profiles stored in database 120 may be updated through rating module 138 in connection with participant profile module 130 and client-side module 130′.

In accordance with some aspects of the present specification, the database system 120 stores a plurality of data organized into one or more data structures or schemas such as, for example, database tables. In some embodiments, the plurality of data comprises, for example, identification data (such as, but not limited to, login ID, password, unique ID, demographic information such as gender, age, account information, rating, and nationality) related to users who are registered for logging into the platform, a plurality of preferences and settings for each player, data related to a plurality of events created by users in the platform (such as, but not limited to, date, time, duration, location, guest parameters, guest incentives), data related to user attendance or participation at events (such as, but not limited to geo-location data and data relating to proximity to other user mobile devices), data indicative of one or more activities (including, for example, date and time stamped logs of activities) that a user engages in within the platform, data related to communications between users within the platform and data related to various transactions performed by users within the platform.

The database system 120 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database system 120 may comprise one or more such databases that reside in one or more physical devices and in one or more physical locations.

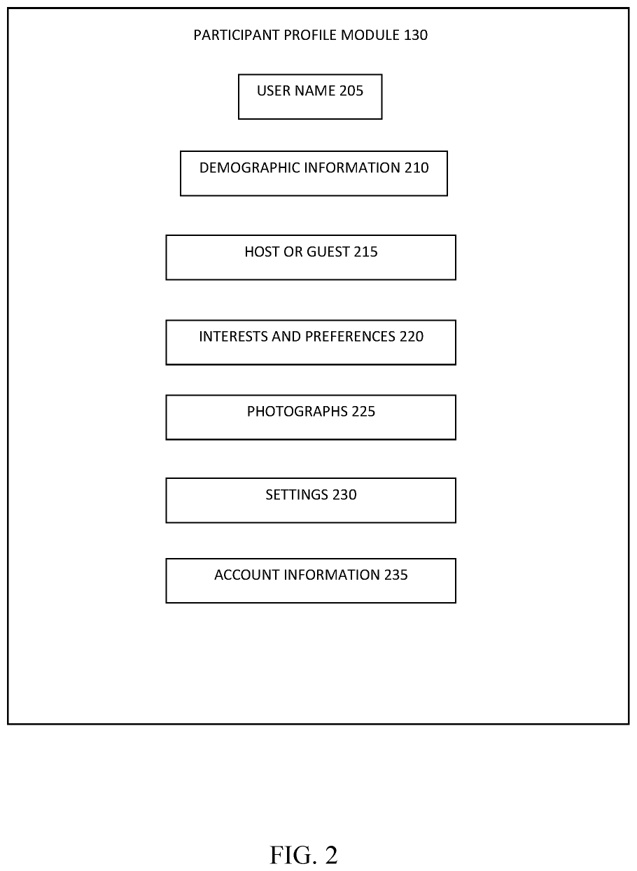

In embodiments, the participant profile module 130 is configured to receive information about users as depicted in FIG. 2 for storage in database 120. For each participant, the user's name 205 is received and stored. The user's name may be a given name or screen name. In embodiments, participant demographic information 210 is received, such as for example, gender, sexual orientation, date of birth, location, ethnicity, religion, language, education other details that may be required or optionally provided by the participant. In embodiments, one or more of the demographic information 210 may be designated as viewable by other participants or maintained private form other participants.

In embodiments, participants may also be asked to identify whether they are interested primarily in being a host or guest 215. In embodiments, the selection of being interested in participating as a guest or host 215 may restrict access within the platform or provide the user with a different interface. For example, those designating themselves as interested in being hosts may be given access to event creation functionality but may be restricted from browsing events. As another example, those designating themselves as interested in being guests may not be given access to event creation functionality but will be allowed to browse posted events.

In other embodiments, the selection of being interested in participating as a guest or host 215 may not limit access within the platform, but alters the presentation and interface generated for the participant by the client module 130′. For example, for those identifying primarily as hosts may have a home page interface that features events the host has posted and user profiles of potential guests but may still navigate to the same functionality available to users identifying primarily as guests. In other embodiments, participants are not asked to identify whether they are interested in being a host or guest and have full access to host and guest features by default.

In embodiments, participants may also be asked to identify personal interests, skills, attributes and preferences 220. For example, participants may designate activities they enjoy engaging in. Participants may also designate special skills, such as proficiency in certain languages, sports, art, science, or professional skills. Participants may also designate preferences they may have for other participants, such as preferred demographic attributes or preferred skills. In embodiments, the data relating to the identification of personal interests, skills and preferences 220 allows users to filter other participants when searching through profiles. In embodiments, the identification of personal interest, skills and preferences 220 may also allow the platform to rank the presentation of search results to participants or provide participants with suggestions for events or other participants who match a participant's specified identifications 220.

In embodiments, users may upload media 225 (including photographs, videos, sound fles or other media) to the platform as part of the participant's profile. In embodiments, certain media may be designated as public allowing all participants in the profile to view the media. In embodiments, certain media may be designated as private, allowing only specific participants in the platform to view the media in accordance with authorization granted by the participant. Participants may also provide certain settings 230 in connection with their profile, such as privacy settings, communication preferences, and data retention preferences. Participants may also provide account information 235 to allow the user to send and receive money within the platform. Participants may also link their profiles to external social media or financial services accounts.

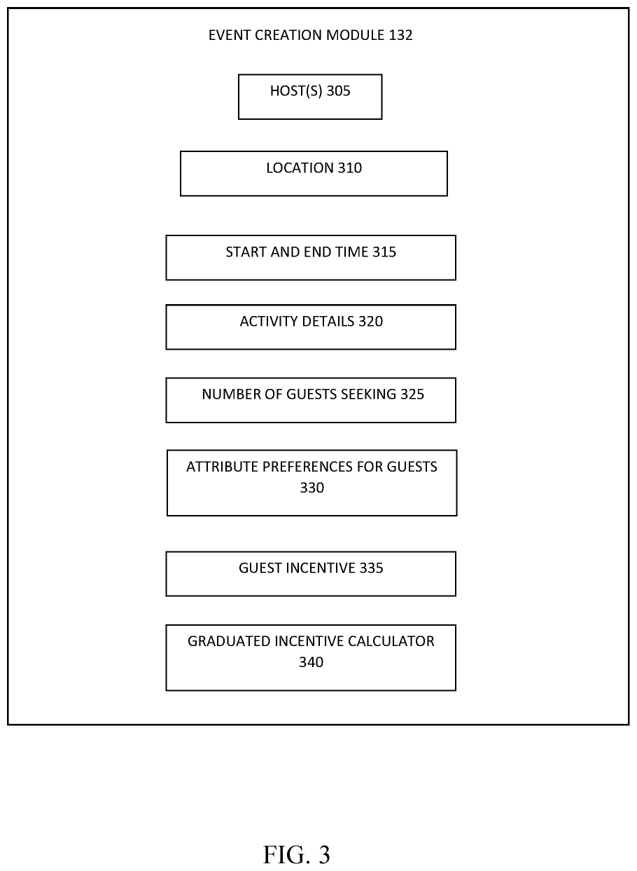

In embodiments, the event creation module 132 is configured to allow participants to create and publish events and receives data inputs fields as depicted in FIG. 3. In embodiments, the event creation module 132 allows a participant to publish an event for attendance by other participants on the platform. The event is associated with a particular participant profile as the event host 305. In embodiments, multiple participants may be identified as hosts (or co-hosts) for a single event. The event host 305 designates the details for the event. In embodiments, the event details may include location 310, start and end time 315, activity details 320, the number of guests the host is seeking 325, attribute preferences for the guests 330 and incentives 335 for guests to participate in the event.

In embodiments, the event host is required to provide a specific location 310 for the event, such as an address or name of a specific establishment. This allows potential guests to verify the safety and acceptability of the event location. In embodiments, the event location 310 may be modified. In embodiments, the event host 305 may specify a location category (e.g., a museum, conference center, restaurant, night club) instead of or in addition to the specific location 310. In embodiments, the platform recommends the event location 310 based on the location category of the event and the locations of event host 305 and guests. In embodiments, the event host 305 is required to provide a start time and end time 315 for the event. In other embodiments, multiple event locations 310 may be designated for different time periods. In embodiments, the event host 305 provides additional activity details 320. For example, the event host may specify the type of activity (such as a social function or a professional service). The event host may also specify whether other people will be in attendance other than guests invited on the platform. In embodiments, the event host 305 specifies the number of guests from the platform the host is seeking to invite 325. The event host 305 may also specify preferred attributes for the guests 330, such as preferred demographic attributes, guest preferences or guest skills. For example, an event host 305 posting an event where the specified activity 320 involves going to a museum, the event host 305 may specify a preference for a guest of a certain gender, age range and having a degree in art history.

In embodiments, the platform may advertise or promote specific venues to encourage participants to host their events at such venues. In embodiments, certain venues may also be designated by the platform as preferred locations based on quality, value, safety or other criteria. In embodiments, participants may be given incentives to host their events at specific locations or venues. For example, participants may be offered discounts, free items or loyalty awards for hosting events at certain venues.

The event host 305 may also specify incentives 335 for guests to attend the event. For example, the event host 305 may specify that each guest attending the event will receive a certain sum of financial incentive (I) for attending the event for the entire duration of the start to end time 315. The event host 305 may also specify other incentives, such as payment of event costs and transportation costs for guests. While the disclosure generally discusses embodiments where the event host 305 gives incentives to guests for attending events, it should be understood that the disclosures herein may also apply to embodiments wherein event host 305 requires guests to pay incentives 335 to attend the event.

In embodiments, the graduated incentive calculator 340 determines a graduated incentive structure for guests to attend the event based on the total incentive designated by the host 335 and the designated duration of the event calculated from the start and end time 315. In embodiments, the graduated incentive calculator 340 automatically determines a graduated payment scale for guests to attend the event with predetermined time intervals marking milestones for the host and guest to either continue or end the event. For example, if the event host specifies an incentive 335 that each guest will receive a certain sum of money (I) for attending the event for the entire event duration (H), the graduated incentive calculator 340 will generate an incentive scale whereby a fraction of I is paid at intervals that are fractions of H representing a certain number of intermediary milestones (M). The time intervals (T) for which incentives are paid according to milestones (M) may be defined by the formula T=H/M. In embodiments, T may represent integer hour intervals, for example, {0, 1, . . . , H}. In other embodiments, T may represent a fraction of the total event duration, such as the half-way point {0, H/2, H}. Additionally and alternatively, milestones (M) may be based on any other user-defined criteria as agreed to between the host and guest including, for example, the guest's completion of pre-defined tasks and/or the guest attending one, some, or all portions of a multi-location event.

The graduated incentive calculator 340 determines and presents to the host different incentive structures for guests to attend an event. For example, the event host may specify an incentive 335 having a maximum value of I for each guest attending an event having a total duration H. In embodiments, the graduated incentive calculator 340 may provide a flat hourly rate for the guest incentive with a bonus payment for guests remaining for the entire duration of the event. For example, the graduated incentive calculator 340 may designated that 0.2*I be reserved for a bonus payment, thereby making the hourly rate for each guest (0.8*I)/H, with only those guests remaining until time H receiving the full amount of I.

In other embodiments, the graduated incentive calculator 340 may provide a flat hourly rate for the guest incentive with a prorated bonus based on the portion of the total duration of time the guest remained at the event. For example, the graduated incentive calculator 340 may designated that 0.2*I be reserved for a bonus payment (B), thereby making the hourly rate for each guest (0.8*I)/H. If a guest stays for the full time H, the guest receives the full amount of I, including the full amount of B. If the duration of a guest's attendance at the event (D) is less than the full time H, the guest may receive only the hourly rate plus the portion of the bonus B multiplied by D/H. In other embodiments, a more graduated incentive structure may be provided, such as an incentive structure based on the following formula:

$$I ( T ) = \frac{{2}^{T}}{{2}^{( H + 1 )} - 1}$$

Such an incentive structure provides increasing incentives to the guest the longer the guest remains in attendance at the event.

In embodiments, after the event details are entered by the host, the host may browse attendee profiles and select users to invite to attend the event. The host may also publish the event details for other users to browse. Other users may request an invitation from the host to attend the event. In other embodiments, the host may browse and select users prior to the inputting of the event details. The host may designate the selected users as the host's favorite users and access a list of those favorite users at a later time. In other embodiments, the host may create an event with one or more of those selected users to be invitees to the event.

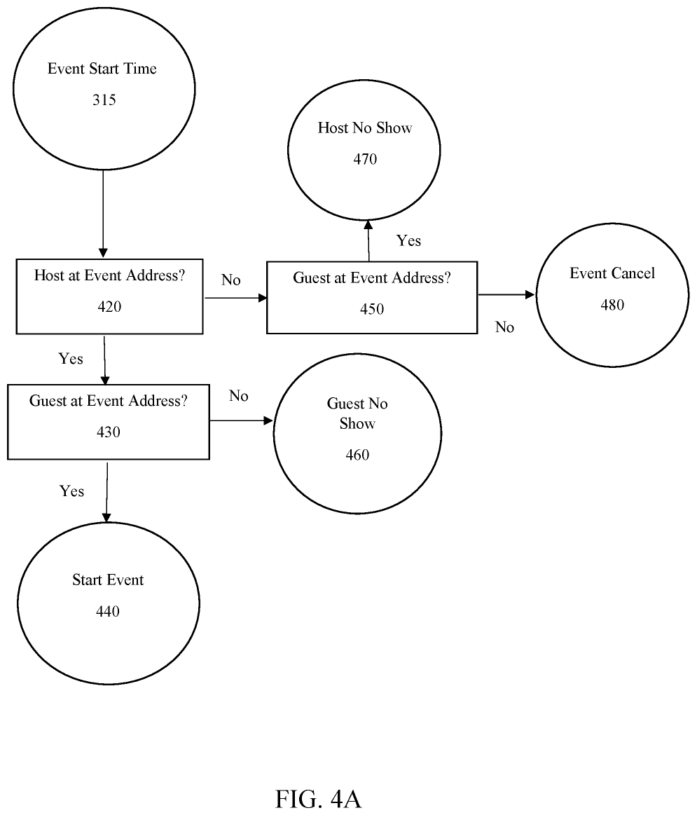

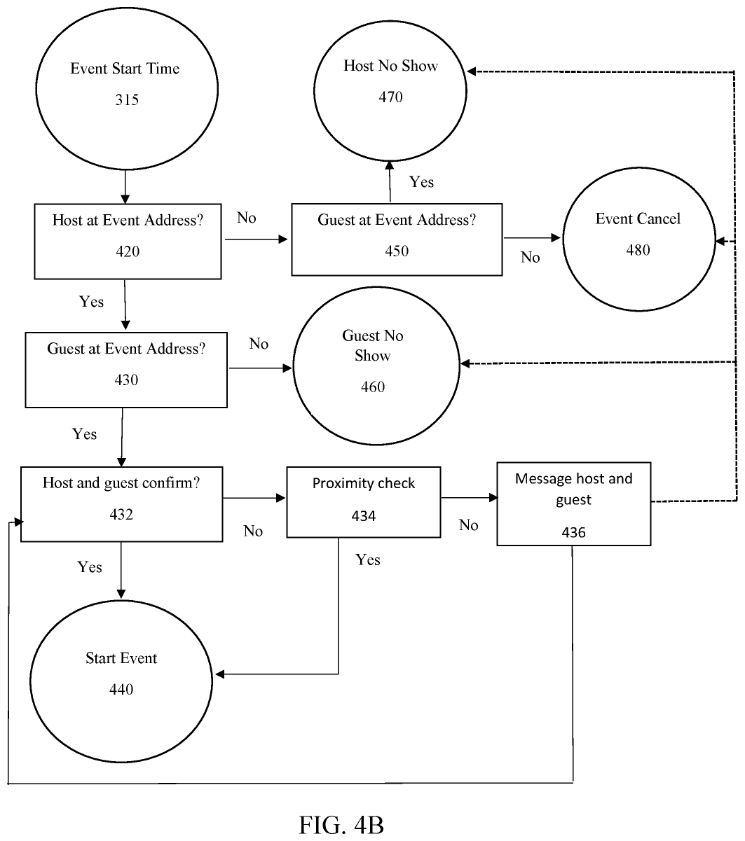

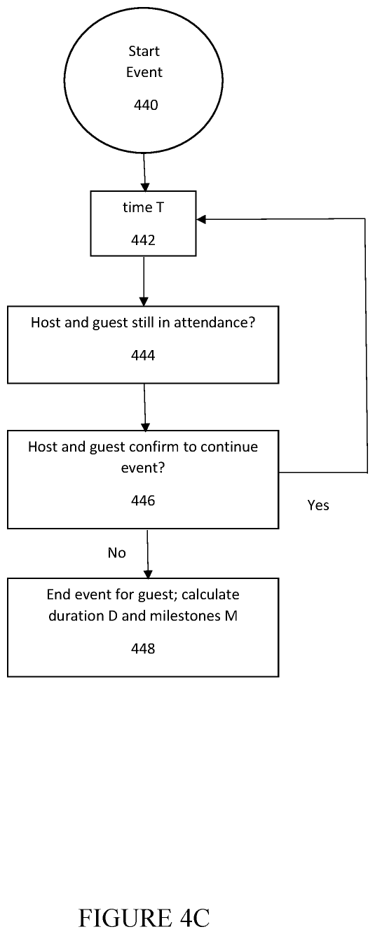

In embodiments, the event verification module 134 executes a verification process of host and guest attendance and performance for an event. FIGS. 4A-4B depict flowcharts for embodiments for one or more processes performed by event verification module 134. It is understood that the attendance verification steps described in FIGS. 4A-4B may be used alternatively, in any combination and in any sequence. FIG. 4A depicts a flowchart for an embodiment of a process executed by event verification module 134 for verifying that the event host(s) and event guest(s) arrived at the specified location 310 for the event at the event start time 315, 410. Beginning at the event start time 315, the host location is received, for example through GPS data provided by the host's mobile device and compared to the address specified for the event 420. The guest location is received, for example through GPS data provided by the guest's mobile device and compared to the address specified for the event 430, 450. If both host and guest are located at the event address, the event is designated as having started 440 for those attendees. If the host is located at the event address, but the guest is not located at the event address, the event guest is designated as not having arrived to the event, or a “no show” 460. If the guest is located at the event address, but the host is not located at the event address, the event host is designated as not arriving to the event, or a “no show” 470. If neither the host nor the guest are located at the event address, the event is designated as canceled 480. In embodiments, the host and guest may override the GPS determination of attendance by guest or host, for example, by being asked to confirm or deny the determination through the client module 130′. In embodiments, the location verifications for guest and host may be repeated over a period of time after the event start time to allow for the host or guest being late. In other embodiments, the sequence of steps depicted in FIG. 4A may be altered, for example by verifying host and guest location in a different sequence or simultaneously.

In other embodiments, prior to start time 315, the guest and host estimated time of arrival may be determined using, for example, GPS data obtained from said guest and host mobile device. The estimated time of arrival data may be communicated to the event host(s) and guest(s). The process of FIG. 4A may be repeated, in whole or part, to verify guest and host attendance throughout the duration of the event. The results of the attendance verification depicted in FIG. 4A may be provided to the payment module 136.

FIG. 4B depicts a flowchart for an embodiment of a process executed by event verification module 134 for verifying that the event host(s) and event guest(s) arrived at the specified location 310 for the event at the event start time 315. Beginning at the event start time 315, the host location is received, for example through GPS data provided by the host's mobile device and compared to the address specified for the event 420. The guest location is received, for example through GPS data provided by the guest's mobile device and compared to the address specified for the event 430, 450.

In certain situations, further or alternative verification of host and guest location may be desirable other than one based on GPS data. For example, if the event is being held at multi-story building, address verification may be insufficient to confirm host or guest attendance at the event. In an embodiment, host and guests are asked to verify their and other users' presence at the event location 432 through the client 110. For example, users may be asked to confirm their presence at the venue. Users may be further asked to confirm other guest's presence at the venue. In other embodiments, users may be asked to confirm their presence through a specific gesture on or with their smartphone or by tapping or “bumping” the smartphone of hosts or attendees. In embodiments, the sequence may proceed to receiving host and guest confirmation 432 regardless of the outcomes of host address determination 420 and guest address determination 430. Such an embodiment would allow users to override address location data that may be inaccurate or in situations where host and guest alter the location.

In embodiments, the host address determination 420 and guest address determination 430 may be skipped altogether, for example, if the users have not enabled access to GPS data on their smartphone. In such embodiments, user verification of attendance may be the first or only step in verifying attendance. In some embodiments, locations may be equipped with means for allowing hosts and guests to indicate their arrival and/or presence at the location. For example, a museum may be equipped with an NFC-based check in terminal or a restaurant may have a barcode or QR code for a host or guests to scan to indicate their arrival.

If both host and guest verify attendance at the event location, the event is designated as having started 440 for those attendees. If verification from both host and guest is not received, the proximity between the guest and host may be determined 434. Proximity between mobile devices 434 may be determined utilizing, for example, near-filed communication (NFC), Bluetooth, or WiFi data of the users' mobile devices to determine if they are within a certain range of each other. Other types of wireless transmission may also be used to verify location and proximity, such as radio frequencies used in connection with Internet of Things (IoT) protocols, including for example LoRaWAN.

As an example, Bluetooth may be utilized to detect the proximity of hosts and guests and the event venue. Bluetooth typically provides a wireless communication range of approximately 10 meters. The host and user Bluetooth MAC addresses may be known by the system. The host's mobile device may perform one or more Bluetooth scans to detect the presence of nearby Bluetooth-enabled devices. If a user's mobile device MAC address is detected within the Bluetooth range of the host's mobile device, host and guest proximity may be inferred. Proximity may also be inferred by using Bluetooth beacons or WiFi fingerprinting. Other approaches may utilize the ability of modern devices to act both as transmitters (known as tethering or portable hot spot mode) and receivers. This feature may be used to estimate the distance between a transmitting and a receiving peer by analyzing RSSI (Received Signal Strength Indicator), which provides the signal strength of the transmitting peer. Other proximity detection techniques may utilize a triangulation algorithm based on the Bluetooth and/or WiFi networks in range of the mobile device.

If the proximity detection data indicates that the host and guest are within a specific proximity of each other, the event may be designated as started 440 for those attendees. Proximity may continue to be measured to confirm guest and host attendance at the event throughout the event duration either continuously or at predetermined time intervals.

If the proximity detection determination 434 indicates that the host and guest are not proximate each other, a message may be sent 436 to the users' client 110. In embodiments, the message may ask the user to contact the other users. In other embodiments, the message may ask the user to provide additional information regarding their location, for example, to describe where in a building or room they are located. In other embodiments, the message may ask the user to allow additional access to the user's mobile device to provide for more accurate location and proximity detection. For example, the user may be asked to enable a beacon on their mobile device.

The host and guest verification 432 and proximity detection 434 may be repeated over a period of time. If after a period of time, host and guest attendance is not verified, the guest may be designated as not having arrived 460, the host may be designated as not having arrived 470 or the event may be designated as canceled 480 if neither the host nor the guest arrived based on the location data received. In embodiments, the process may proceed similarly to FIG. 4A, wherein if the host is located at the event address, but the guest is not located at the event address, the event guest is designated as not having arrived at the event, or a “no show” 460. If the guest is located at the event address, but the host is not located at the event address, the event host is designated as not arriving to the event, or a “no show” 470. If neither the host nor the guest are located at the event address, the event is designated as canceled 480.

In other embodiments, host and guest verification 432 and proximity detection 434 may be performed independently of the outcome of the host or guest being located at the event 420, 430. In other embodiments, event attendance may be verified through host and guest verification 432 or proximity detection 434 may be conducted without an address determination 420, 430 being performed. Such embodiments may be preferable when host or guest prefer to maintain their location information private. Additionally or alternatively, other methods of verifying guest and host attendance may be used. For example, the event software may provide an in-app camera that allows participants to take a timestamped photo of themselves at the location for uploading to event verification module 134 as evidence of attendance.

In embodiments, the location verifications for guest and host may be repeated over a period of time after the event start time to allow for the host or guest being late. The process of FIG. 4B may be repeated, in whole or part, to verify guest and host attendance throughout the duration of the event. The results of the attendance verification depicted in FIG. 4B may be provided to the payment module 136.

FIG. 4C depicts a flowchart for an embodiment of a process for confirming through the duration of an event, at specified time intervals, that the host and guest wish to continue with the event. The event is designated as started 440 as described in FIGS. 4A and 4B. After a time interval T 442, the system verifies whether both the host and guest are still in attendance at the event 444. This may be performed following the verification processes described in connection with 4A and 4B. Host and guest are then asked if they wish to continue with their attendance of the event 446. If both host and guest confirm that they wish to continue with attending the event, the process is repeated after another time interval T 442. If either host or guest or both communicate that they do not wish for both to continue with attendance of the event, the event is ended for that guest and the guest's attendance duration is calculated 448. The host and guest may receive a communication indicating that the other did not wish to continue with the event. In some embodiments, it may be desirable to delay the communication. For example, if a host indicates a desire to continue the event with a particular guest, but the guest indicates a desire to end the event, it may be desirable to delay communicating to the host that guest's election to avoid a confrontation. In such embodiments, the geo-location and proximity verification process may be used to determine when communication to the host is optimal, for example, to ensure that the guest is a safe distance from the host. The guest's duration of attendance is compared to the milestone and incentives determined by the host when creating the event 448.

In embodiments, users' attendance and participation in the event may be verified using a smart contract or blockchain wherein each user provides verification of the completion of some or all of the event using an encrypted token. In embodiments, users may memorialize the event with media, such as an audiovisual recording, that is authenticated by one or more other users using a non-fungible token. In such embodiments, a user may capture a moment of the event, for example by video. Other users may authenticate the video and their attendance at the event and presence in the video using an non-fungible token associated with that user. A non-fungible token (NFT) is a unit of data stored on a digital ledger, called a blockchain, that certifies a digital asset to be unique and therefore not interchangeable. An NFT functions like a cryptographic token. This cryptographic transaction process ensures the authentication of each digital file by providing a digital signature that is used to track NFT ownership. In this way, hosts or attendees may create an authenticated and unique asset that captures the event and verifies the attendance and participation of one or more of its attendees. This may be desirable if, for example, a high-status individual is in attendance at the event.

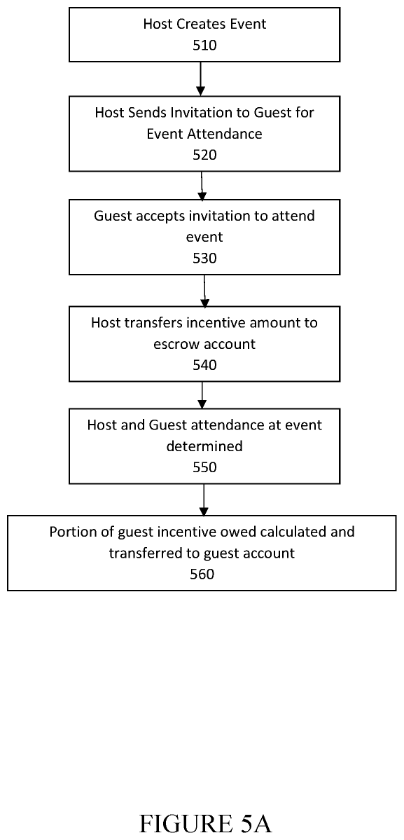

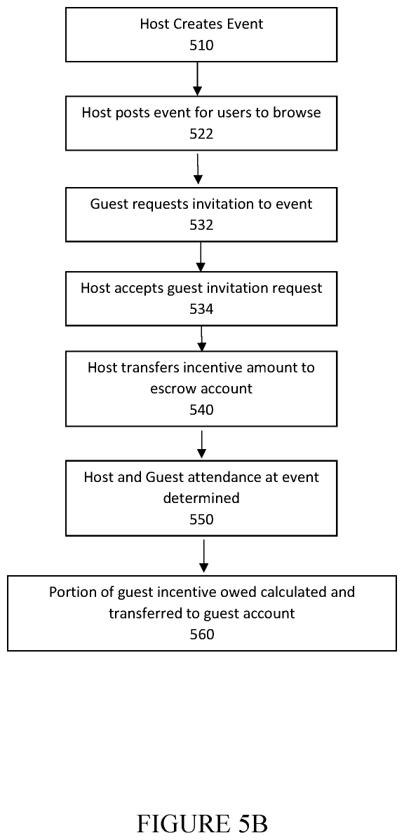

FIG. 5A depicts a flowchart for an embodiment of a process for creation, attendance verification and guest payment executed by event creation module 132, event verification module 134 and payment module 136. The event host creates an event 510 using event creation module 132. The host sends an invitation to one or more guests to attend the event 520. One or more guest invitees may accept the invitation 530 confirming their intent to attend the event. Host then deposits the guest incentive amounts specified for the event into an intermediary account 540 using payment module 136. Attendance at the event by the host and guest is verified 550 using event verification module 134. Based on the host and guest attendance verification, payments are made to each guest 560 according to the incentive structure and milestones established for the event.

FIG. 5B depicts a flowchart for an embodiment of a process for creation, attendance verification and guest payment executed by event creation module 132, event verification module 134 and payment module 136. The event host creates an event 510 using event creation module 132. The host posts the event for other users to browse 525. One or more guests may express interest in attending the event 532 and request from the host an invitation to the event. Host may confirm the invitation of one or more guests 534. Host then deposits the guest incentive amounts specified for the event into an intermediary account 540 using payment module 136. Attendance at the event by the host and guest is verified 550 using event verification module 134. Based on the host and guest attendance verification, payments are made to each guest 560 according to the incentive structure and milestones established for the event.

In some embodiments, virtual currency, including digital currency or cryptocurrency, may be used. In such embodiments, incentives and event transactions between guests and hosts may be defined and conducted using virtual currency. Hosts may purchase virtual currency using other currencies or hosts may earn virtual currency through performing certain activities. Guests may exchange virtual currency for real-world or virtual objects or other currencies, through payment module 136. In some embodiments, virtual currency may be virtual items such as tokens, coins, gems, cryptocurrency, roses, candies, shoes or any other virtual item. In embodiments, the host can choose one or more specific virtual items to purchase and use among a plurality of virtual items. In some embodiments, the unit cost of virtual currency varies based on the volume of virtual currency being purchased.

In other embodiments, users are rated using rating module 138 based on their attendance verification outcomes. For example, if an event was scheduled to have a total duration of H hours and a guest attended the guest for D hours, that user's rating R for that event may be calculated by the formula R=D/H. Additionally or alternatively, other attendance verification outcomes may be used, including for example, the rate at which the user fails to show up at events, their rate of completing an entire event, and/or their punctuality. In this way, the rating of users is based on an objective measure of their attendance, removing biases and subjectivity inherent in peer review systems.

In some embodiments, users may purchase passes that offer protection from negative ratings. For example, a user may purchase a “no show” pass, that exempts one “no show” from resulting in a negative rating. In some embodiments, all or a portion of the pass's purchase price is credited to the other user in the event transaction (e.g., the user that arrived at the event as scheduled). In some embodiments, the number of passes a user may purchase or use is limited (e.g., no more than X passes per Y months or no more than X passes per Y successfully attended events).

In embodiments, the platform may promote and incentivize the achievement of event milestones. For example, the client module 130′ can provide encouraging and celebratory graphics and sounds for the achievement of milestones. The platform may also establish incentives with the event venue for the achievement of milestones, for example, a free food or beverage item at predetermined milestone achievements. In embodiments, the platform may also provide incentives within the platform for achieving certain milestones or participating in a certain number of events having a achieved a certain number of milestones. For example, the platform may provide preferential listing for participants or events, provide free “no show” passes, provide discounts at the venue, for transportation, for attendees incentives or other event costs, or host free events.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. An apparatus, comprising:
a server that includes a processor and a memory, the server being configured to interface with one or more end users and to manage information related to one or more of the end users, wherein the server is further configured to receive from a first user fields defining an in-person event, said fields including an event start time, event end time, event location, number of attendees, financial incentive for attendance and one or more preferred attributes of said attendees;
wherein said server is further configured to determine a set of end users for attendance at said event based on said fields and send said set of end users a message indicating a request to attend said event, wherein said server is further configured to receive from said set of end users a message indicating whether one or more end users within said set of end users accepts said request to attend said event;
wherein said server is further configured to verify, prior to said event start time, that said first user has deposited a minimum amount of money into a financial account, said minimum amount being determined based on said number of attendees, said incentive and a predetermined time for verifying the attendance of said attendees and said first user's and attendees to continue attending said event;
wherein said server is further configured to receive from said end user mobile devices location information to compare during said start time and said end time the location of end users and with said event location, wherein said server is further configured to receive from said end users at said predetermined time a message indicating whether said end users intend to continue said event;
wherein said server is further configured to send instructions indicating the amount of money owed to said end users based on said comparison of said location information with said event location and said message indicating whether said end users intend to continue said event.

2. An apparatus as claimed in claim 1, further comprising: wherein said server is further configured to attribute to said end users a rating based on said comparison of said location information with said event location and said message indicating whether said end users intend to continue said event.

3. An apparatus as claimed in claim 1, further comprising: when said comparison of said end user mobile devices location information with said event location indicates that said end user is located at said event location at said event start time, said server is further configured to send an instruction to said end user mobile device to execute an audiovisual display on said end user mobile device;

4. An apparatus as claimed in claim 1, further comprising: when said server receives from said first user at said predetermined time a message indicating said first user wishes to continue said event with a second user and when said server receives from said attendee at said predetermined time a message from said second user, said server further configured to send to said mobile device of said first user and said second user an instruction to execute an audiovisual display on said mobile device of said first user and said mobile device of said second user.

5. An apparatus in claim 1, further comprising: wherein said server is further configured to receive from said end use mobile device a message that said user mobile device has scanned a QR code associated with said event location.

6. An apparatus in claim 1, further comprising: when said comparison of said end user mobile devices location information with said event location indicates that said end user is located at said event location at said event start time, said server is further configured to send to other end users a message indicating that said event has started.

7. An apparatus in claim 1, further comprising: when said comparison of said end user mobile devices location information with said event location indicates that said end user is located at said event location at said event start time, said server is further configured to award said end user virtual currency.

8. An apparatus as claimed in claim 1, further comprising: when said server receives from said first user at said predetermined time a message indicating said first user wishes to continue said event with a second user and when said server receives from said attendee at said predetermined time a message from said second user, said server further configured to award said first user and said second user virtual currency.

9. An apparatus as claimed in claim 1, further comprising: wherein said server is further configured to receive from said one or more end users an audiovisual data file representative of said event, said server further configured to receive an authentication code from one or more end users associated with said audiovisual data file.

10. An apparatus as claimed in claim 9, further comprising: wherein said server is further configured to receive a request from a said end user to share said audiovisual data file with other end users and wherein said server is further configured to send to other end users said audiovisual file with indication of said authentication associated with said audiovisual data file.

11. A non-transitory computer storage medium encoded with computer program instructions providing a software application operable on a user mobile device having an RF receiver and transmitter, the software application when executed by a mobile device causes the mobile device to perform operations comprising:
receiving from a first user information regarding an in-person event hosted by said first user, said information including a start time, end time, location and number of people sought by said user to attend said event;
receiving mobile device identification information from said first user;
responsive to a request from said first user, sending to a second user an invitation to attend said event;
responsive to a request from said second user, sending to said first user an acceptance of said invitation;
receiving mobile device identification information for said second user;
at said start time, determining the geo-location of the mobile device for said first user and said second user event attendees and comparing said geo-location to said location specified by said first user for said event;
at said start time, determining whether first user mobile device RF transmitter and receiver is within the range of said RF transmitter and receiver of said second user mobile device;
designating the event to have started for said first user and second user if geo-location indicates said first user and said second user are present at the specified event address and said first user and said second user are proximate;
at specified time intervals after said designating the event to have started until said end time, determining the geo-location and proximity of mobile devices of said first user and said second user and receiving from said first user and said second user an indication of whether said first user and said second user desire to continue attending said event;
calculating the duration said first user and said second user attended said event.

12. A non-transitory computer storage medium encoded with computer program instructions providing a software application operable on a user mobile device having an RF receiver and transmitter, as claimed in claim 11, the software application when executed by a mobile device causes the mobile device to perform the further operations comprising:
assigning to said first user a rating based on said duration of said first user and said second user attending said event;
assigning to said second user a rating based on said duration of said first user and said second user attending said event.

13. A non-transitory computer storage medium encoded with computer program instructions providing a software application operable on a user mobile device having an RF receiver and transmitter, as claimed in claim 11, the software application when executed by a mobile device causes the mobile device to perform the further operations comprising:
responsive to said first user indicating a desire to continue said event with said second user and responsive to said second user indicating a desire not to continue said event with said first user, delaying the communication to said first user of said second user said indicating a desire not to continue said event until geo-location and proximity information indicates that said first user and said second user are in different locations.

14. A non-transitory computer storage medium encoded with computer program instructions providing a software application operable on a user mobile device having an RF receiver and transmitter, as claimed in claim 11, the software application when executed by a mobile device causes the mobile device to perform the further operations comprising:
at a specified time prior to said start time of said event, estimating the distance of said second user from said event location and communicating to said first user geo-location of said second user and estimated time of arrival at said event location.

15. A non-transitory computer storage medium encoded with computer program instructions providing a software application operable on a user mobile device having an RF receiver and transmitter, as claimed in claim 11, the software application when executed by a mobile device causes the mobile device to perform the further operations comprising:
responsive to a request received from said first user, publishing said event information;
responsive to a request received from said second user, communicating to said first user that said second user is interested in attending said event;
responsive to a request received from said first user, communicating to said second user that said first second user has accepted said second user request to attend said event.

16. A non-transitory computer storage medium encoded with computer program instructions providing a software application operable on a user mobile device having an RF receiver and transmitter, as claimed in claim 11, the software application when executed by a mobile device causes the mobile device to perform the further operations comprising:
receiving from said first user a commitment to enter into a first financial transaction with said second user based on said second user duration of attendance at said event;
responsive to said calculating the duration said first user and said second user attended said event, requesting execution of all payments to be made under terms of the first financial transaction.

17. A non-transitory computer storage medium encoded with computer program instructions providing a software application operable on a user mobile device having an RF receiver and transmitter, as claimed in claim 15, the software application when executed by a mobile device causes the mobile device to perform the further operations comprising:
responsive to said receiving from said first user a commitment to enter into a financial transaction with said second user, determining a payment scale and milestones for said second user to attend said event.

18. A non-transitory computer storage medium encoded with computer program instructions providing a software application operable on a user mobile device having an RF receiver and transmitter, as claimed in claim 15, the software application when executed by a mobile device causes the mobile device to perform the further operations comprising:
responsive to said receiving from said first user a commitment to enter into a financial transaction with said second user, determining a graduated payment scale and milestones for said second user to attend said event.

19. A non-transitory computer storage medium encoded with computer program instructions providing a software application operable on a user mobile device having an RF receiver and transmitter, as claimed in claim 15, the software application when executed by a mobile device causes the mobile device to perform the further operations comprising:
responsive to said receiving from said first user a commitment to enter into a financial transaction with said second user, determining a payment scale and milestones for said second user to attend said event, said milestones based on specified intervals of time indicating duration that said first user and said second user attend said event;
prior to said event start time, receiving from said first user payments to be made under terms of said first financial transaction;
holding said payments until completion of at least one of said milestones;
responsive to completion of at least one of said milestones, sending to said second user payments under terms of said first financial transaction.

20. A computer-based method for verifying user attendance at in-person events through a user's mobile device, the method comprising the steps of:
receiving the start time, end time and location for said event from a user hosting said event;
receiving mobile device identification information for each attendee;
at said start time, determining the geo-location of the mobile device for event attendees and comparing said geo-location to said location specified by said user hosting said event;
determining the proximity between said event attendees using radio frequency transmitters and receivers on said user's mobile devices and said received mobile device identification information;
designating the event to have started for each attendee whose geo-location indicates they are present at the specified event address and proximate said user hosting said event;
determining the geo-location and proximity of user mobile devices for attendees that were designated to have started said event throughout the specified duration of said event;
receiving from each attendee that was designated to have started said event a message indicating whether said attendee desires to continue attending said event and receiving from said event host a message indicating whether said host desires each attendee to continue attending said event;
calculating based on said geo-location and proximity of user mobile devices the duration each attendee remained at said event;
ascribing to each user a rating based on said duration each attendee remained at said event and said received indication from said attendee and said host
